(19) United States
(12) Patent Application Publication
(10) Pub. No.: US 2026/0246694 A1
(43) Pub. Date: Aug. 20, 2026

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventors: Ryota KOMORI, Kanagawa (JP); Shota Funaki, Kanagawa (JP); Yoshihiro Takeshita, Kanagawa (JP)

(73) Assignee: FUJIFILM Business Innovation Corp., Tokyo (JP)

(21) Appl. No.: 19/272,397

(22) Filed: Jul. 17, 2025

(30) Foreign Application Priority Data
Feb. 18, 2025 (JP) 2025-024284

(51) Int. Cl. H04L 41/0813; G06F 9/445

(52) U.S. Cl. CPC H04L 41/0813; G06F 9/44505

(57) ABSTRACT

An information processing system includes: a processor configured to: store a set value of an information processing device serving as a management target, as a set value synchronously in a management device by performing synchronous communication with the information processing device; in response to a setting change request for changing a set value being received from a remote device, change the stored set value on a basis of the received setting change request and transfer the received setting change request to the information processing device; and in response to a difference between the set value of the information processing device serving as the management target and the set value stored in the management device in executing a synchronization process, in response to priority being given, in a priority setting for deciding which one of set values is given priority, to the set value of the information processing device serving as the management target, in response to the set value being changed on the basis of the setting change request from the remote device, in response to the synchronization process being executed, and in response to time when the setting change request is transmitted from the remote device being earlier than time when a previous synchronization process is executed, transmit, to a report destination set in advance, a report for suggesting that the set value be verified as an intended set value.

### CROSS-REFERENCE TO RELATED APPLICATIONS

This application is based on and claims priority under 35 USC 119 from Japanese Patent Application No. 2025-024284 filed Feb. 18, 2025.

### BACKGROUND

### (i) Technical Field

The present disclosure relates to an information processing system, a non-transitory computer readable medium, and an information processing method.

### (ii) Related Art

Japanese Unexamined Patent Application Publication No. 2024-006386 discloses a service providing system including a first device that has first attribute data and that includes an execution unit and a second device that has second attribute data corresponding to the first attribute data and that includes a shadow execution unit. The first attribute data includes state information regarding the first device and settings information regarding functions of the first device. In response to an instruction regarding the execution of a function, the execution unit executes the function designated in the instruction by using the first attribute data in cooperation with an agent unit. The shadow execution unit executes a process in the instruction received from a service and a process requested by the execution unit.

### SUMMARY

There has been proposed a system in which synchronous communication between an information processing device serving as a management target and a management device and in which the management device thereby stores and manages set values in the management target information processing device. In some cases, the system as described above is designed to be able to change a set value stored in the management device and also a set value in the management target information processing device in such a manner that a setting change request for changing the set value stored in the management device is transmitted from a remote device to the management device.

However, a failure or the like in a communication network between the remote device and the management device causes the setting change request transmitted from the remote device to the management device to reach the management device later than usual on occasions. In such a case, the set value of the management target information processing device is changed to a set value not intended by the user in the following situation: a user transmits a setting change request from the remote device to the management device, the set value is thereafter changed to a set value different from an operation panel or the like of the management target information processing device, and the setting change request from the remote device reaches the management device late.

Aspects of non-limiting embodiments of the present disclosure relate to providing an information processing system, a non-transitory computer readable medium, and an information processing method by which if a setting change request as an instruction to change a set value of a setting reaches a management device late, a user is able to know that the set value has been changed to a set value not intended by the user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including:
a processor configured to:
   store a set value of an information processing device serving as a management target, as a set value synchronously in a management device by performing synchronous communication with the information processing device;
   in response to a setting change request for changing a set value being received from a remote device, change the stored set value on a basis of the received setting change request and transfer the received setting change request to the information processing device; and
   in response to a difference between the set value of the information processing device serving as the management target and the set value stored in the management device in executing a synchronization process, in response to priority being given, in a priority setting for deciding which one of set values is given priority, to the set value of the information processing device serving as the management target, in response to the set value being changed on the basis of the setting change request from the remote device, in response to the synchronization process being executed, and in response to time when the setting change request is transmitted from the remote device being earlier than time when a previous synchronization process is executed, transmit, to a report destination set in advance, a report for suggesting that the set value be verified as an intended set value.

### BRIEF DESCRIPTION OF THE DRAWINGS

An exemplary embodiment of the present disclosure will be described in detail based on the following figures, wherein:

FIG. 1 is a view illustrating the system configuration of an information processing system of an exemplary embodiment of the present disclosure;

FIG. 2 is a view illustrating an outline of operations in the information processing system of the exemplary embodiment of the present disclosure;

FIG. 3 is a table for explaining priority setting modes in a synchronization process;

FIG. 4 is a view for explaining operations of an image forming device performed in a case where a setting item for the image forming device is set to have a set value not intended by an administrator;

FIG. 5 is a table illustrating the change history of set values for Setting A in processing steps (1) to (8) illustrated in FIG. 4;

FIG. 6 is a view illustrating the hardware configuration of a management server in the information processing system of the exemplary embodiment of the present disclosure;

FIG. 7 is a block diagram illustrating the functional configuration of the management server in the information processing system of the exemplary embodiment of the present disclosure;

FIG. 8 is a table illustrating an example of a change history management table stored in a change history information storage unit;

FIG. 9 is a table illustrating logic state conditions for a setting change path flag;

FIG. 10 is a flowchart illustrating processing performed by a controller in transmitting a verification report;

FIG. 11 is a view illustrating processing steps in which the administrator receives change history information regarding Setting A and a verification report and operations after the receiving; and

FIG. 12 is a table illustrating the change history of the set values for Setting A in the processing steps (9) to (11) illustrated in FIG. 11.

### DETAILED DESCRIPTION

An exemplary embodiment of the present disclosure will then be described in detail with reference to the drawings.

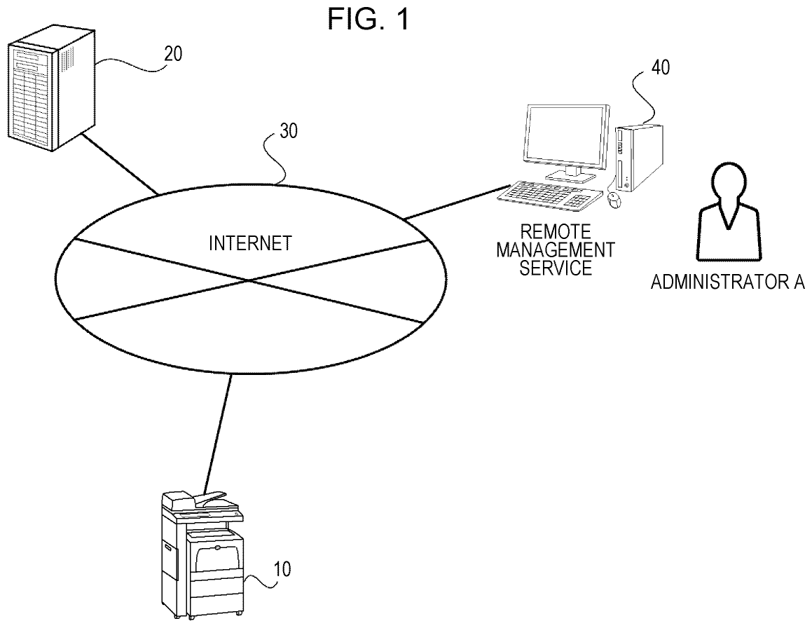

FIG. 1 is a view illustrating the system configuration of an information processing system of an exemplary embodiment of the present disclosure.

The information processing system of the exemplary embodiment of the present disclosure is a system for management of an image forming device 10 as a management target device by a management server 20 as a management device. As illustrated in FIG. 1, the information processing system of this exemplary embodiment has a configuration in which the management server 20, the management target image forming device 10, and a terminal device 40 operated by an administrator A are connected via the Internet 30. The administrator A is able to change a set value of the image forming device 10 by using the terminal device 40 via a remote management service. The image forming device 10 is a device generally called a multifunction printer having multiple functions such as a printing function, a scanning function, a copying function, and a facsimile function.

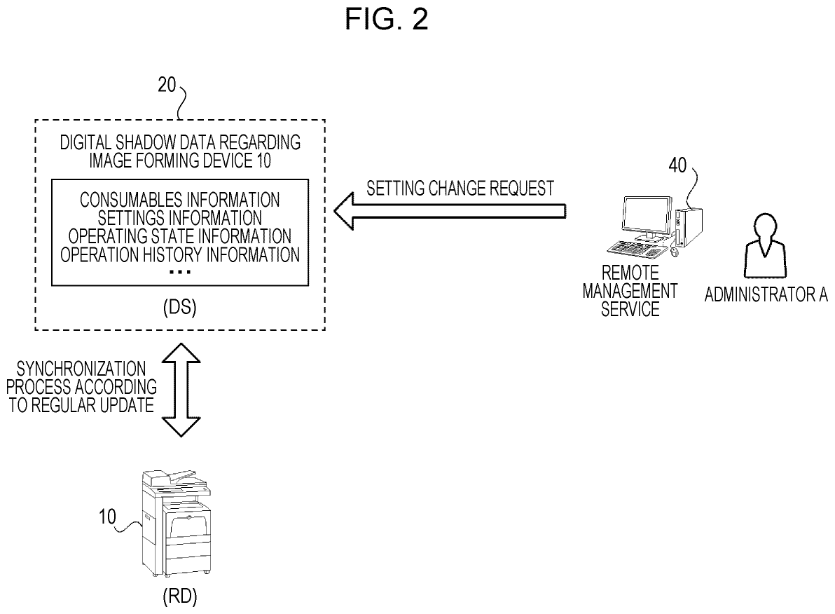

Outline of operations in the information processing system of this exemplary embodiment will then be described by using FIG. 2.

In the information processing system of this exemplary embodiment, the management server 20 manages various pieces of state information such as settings information regarding the image forming device 10, consumables information such as a remaining toner amount, operating state information, and operation history information such as information regarding the number of prints. Specifically, the management server 20 provides a service of synchronously holding, as digital shadow data, various pieces of information such as settings information stored in the image forming device 10 that is a physical device connected via the Internet 30. In the digital shadow, the management server 20 thus stores data obtained by digitally duplicating information regarding set values, the operating states, and the like of the image forming device 10 that is the physical device.

The administrator A is able to acquire the various pieces of information stored in the management server 20 and change the various pieces of information thus stored, by using the remote management service through operation of the terminal device 40. The administrator A is also able to change a set value in the settings information in the management server 20 in such a manner as to transmit a setting change request from the terminal device 40 to the management server 20. The management server 20 that has received the setting change request from the terminal device 40 changes digital shadow data in the management server 20, transfers the received setting change request to the image forming device 10, and thereby changes the set value of the image forming device 10. The setting change in response to the setting change request is performed regardless of a process for synchronizing the management server 20 and the image forming device 10.

In the following description, the image forming device 10 and digital shadow data in the management server 20 are respectively simply referred to as a real device (RD) and DS on occasions.

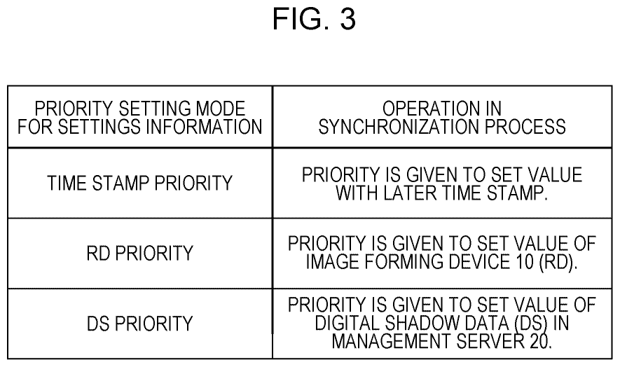

As described above, the image forming device 10 and the management server 20 execute the synchronization process on the stored information at regular intervals, for example, every several hours. For the settings information, the synchronization process is executed on the basis of a priority setting mode as illustrated in FIG. 3.

Specifically, in the case of the priority setting mode “Time Stamp Priority”, a synchronization process is executed in which priority is given to a set value with a later time stamp, that is, change time. In the case of the priority setting mode “RD Priority” giving priority to RD, that is, the image forming device 10 that is an actual physical device, a synchronization process is executed in which priority is given to the set value of the image forming device 10. That is, in the case of the priority setting mode “RD Priority”, if there is a difference between the set value of the image forming device 10 and the set value in the settings information in the digital shadow data in the management server 20, the set value of the image forming device 10 overwrites the digital shadow data.

In the case of the priority setting mode “DS Priority” in which priority is given to the digital shadow data in the management server 20, a synchronization process is executed in which priority is given to the set value in the digital shadow data.

For example, the set value of a setting item in the image forming device 10 is “3”, and the set value of the setting item is “2” in the digital shadow data. In this case, if RD Priority is set as the priority setting for the setting item, the set value “3” of the image forming device 10 overwrites the set value in the digital shadow data with “3”. On the other hand, if DS Priority is set as the priority setting for the setting item, the set value “2” in the digital shadow data overwrites the set value of the image forming device 10 with “2”.

The administrator A is able to change a set value of the image forming device 10 through remote operation in such a manner as to transmit a setting change request to the management server 20 by using the remote management service via the terminal device 40. Suppose a case where the setting change request reaches the management server 20 late due to a communication equipment failure or the like, and RD Priority has been set as the priority setting mode for a setting item. In this case, there is a possibility that the set value of the setting item is changed to a set value not intended by the administrator A who is the user.

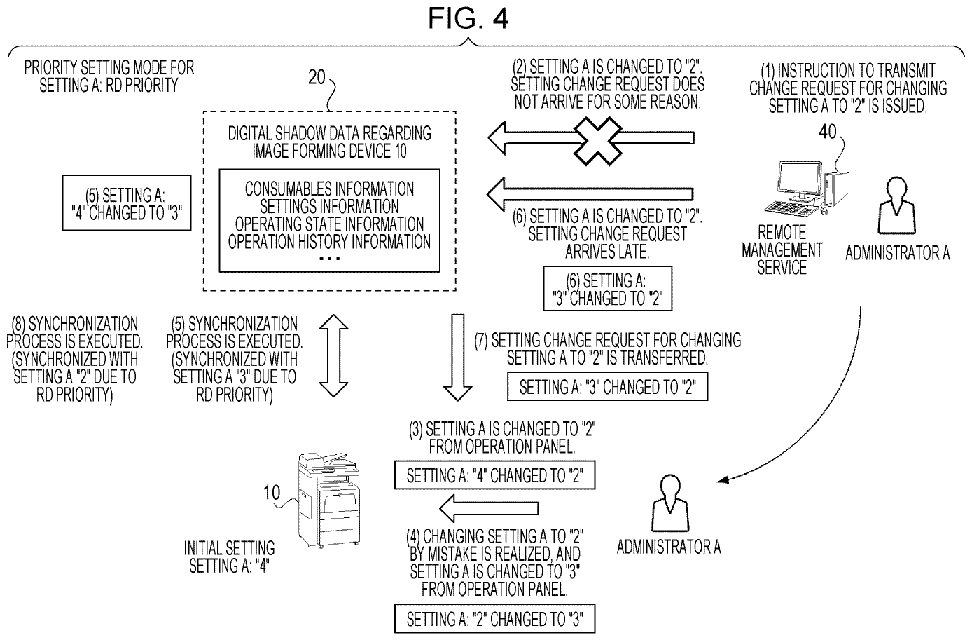

Operations of the image forming device 10 performed in the case where a set value of a setting item for the image forming device 10 is set to a set value not intended by the administrator A as described above will be described with reference to FIG. 4.

A case of changing the set value of a setting for a setting item that is Setting A in the image forming device 10 will be described below. In the description, RD Priority has been set as the priority setting mode for Setting A. The description is provided on the assumption that the image forming device 10 and the digital shadow data have been synchronized and have the respective set values “4” of Setting A in the initial state.

(1) The administrator A transmits a setting change request for changing Setting A to “2” to the management server 20 by operating the terminal device 40.

(2) However, the setting change request does not reach the management server 20 for some reason such as a communication failure.

(3) Subsequently, the administrator A moves to the installation place of the image forming device 10 and changes Setting A to “2” by operating the operation panel of the image forming device 10. The operation by the administrator A causes the set value of Setting A for the image forming device 10 to be changed from “4” to “2”.

(4) However, the administrator A realized that Setting A has been changed to “2” by mistake and changes Setting A to “3” by operating the operation panel. The operation by the administrator A causes the set value of Setting A for the image forming device 10 to be changed from “2” to “3”.

(5) After the change, a process for synchronizing the management server 20 and the image forming device 10 is executed. In this case, RD Priority has been set as the priority setting mode for Setting A, and thus the set value of Setting A in the digital shadow data in the management server 20 is changed from “4” to “3”.

(6) The setting change request has not reached the management server 20 for some reason but reaches the management server 20 late after the synchronization process in (5). The setting change request that has reached the management server 20 late indicates that the set value of Setting A is to be changed to “2”. The management server 20 thus changes the set value of Setting A in the digital shadow data from “3” to “2” on the basis of the received setting change request.

(7) The management server 20 then transfers the received setting change request to the image forming device 10. In response to this, the image forming device 10 changes the set value of Setting A from “3” to “2” on the basis of the setting change request from the management server 20. As described above, the change in response to the setting change request is performed at timing different from the synchronization process and regardless of the priority setting mode.

(8) Thereafter, the process for synchronizing the management server 20 and the image forming device 10 is executed. In this case, the set value of Setting A in the digital shadow data in the management server 20 and the set value of Setting A for the image forming device 10 are both “2”, and thus the synchronization process is executed to cause Setting A to have the set value “2”.

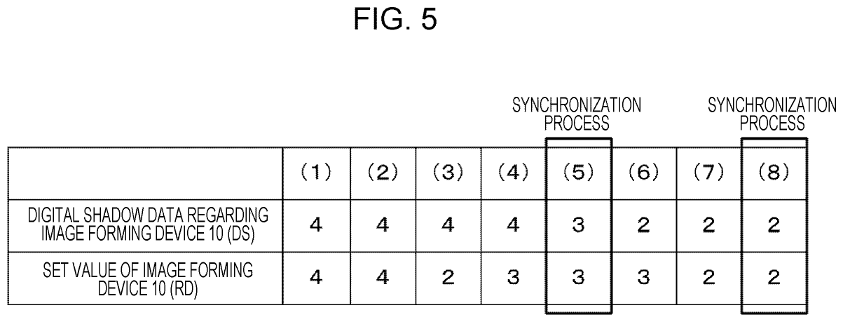

FIG. 5 illustrates a change history of set values of Setting A in the processing steps (1) to (8) as described above.

As understood with reference to FIG. 5, performing the processing steps (1) to (8) as described above finally leads to the set value “2” of Setting A in both of the image forming device 10 and the digital shadow data in the management server 20. However, the administrator A who is the user does not intend to set the set value “2” of Setting A and is supposed to intend to finally have the set value “3” of Setting A.

Hence, the information processing system of this exemplary embodiment is configured such that even if a setting change request as an instruction to change the set value of a setting reaches the management server 20 late, performing control as to be described below enables the administrator A who is the user to know that the set value has been changed to a set value not intended by the administrator A.

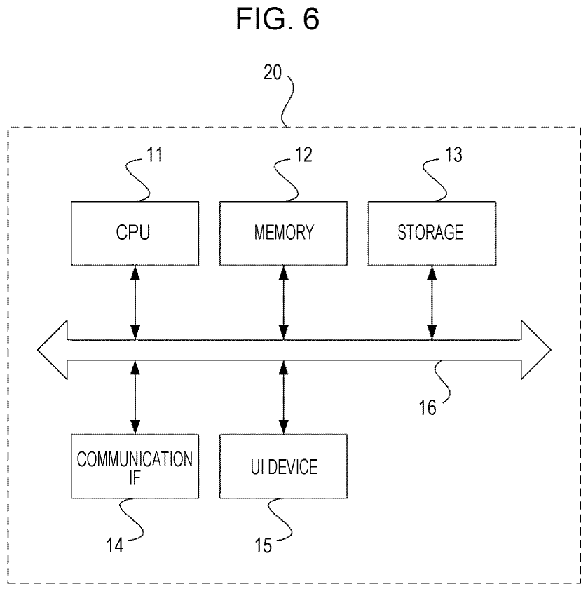

FIG. 6 illustrates the hardware configuration of the management server 20 in the information processing system of this exemplary embodiment.

As illustrated in FIG. 6, the management server 20 has a CPU 11, a memory 12, a storage 13 such as a hard disk drive, a communication interface (abbreviated as IF) 14 that exchanges data with an external device or the like via the Internet 30, and a user interface (abbreviated as UI) device 15 including a touch panel or a liquid crystal display as well as a keyboard. These components are connected to each other via a control bus 16.

The CPU 11 is a processor configured to perform control of the operations of the management server 20 by performing predetermined processes on the basis of a control program stored in the memory 12 or the storage 13. In the description for this exemplary embodiment, the CPU 11 reads out and runs the control program stored in the memory 12 or the storage 13; however, how to providing the control program is not limited to this. The control program may be provided in such a manner as to be recorded in a computer readable recording medium. For example, the program may be provided in such a manner as to be recorded in an optical disk such as a digital versatile disc (DVD)-read only memory (ROM) or a compact disc (CD)-ROM, a semiconductor memory such as a universal serial bus (USB) memory, or a memory card. The control program may also be acquired from an external device via a communication network connected to the communication interface 14. Further, the control program may be provided as, for example, single application software or may be incorporated as one of the functions of the management server 20 into software of devices thereof.

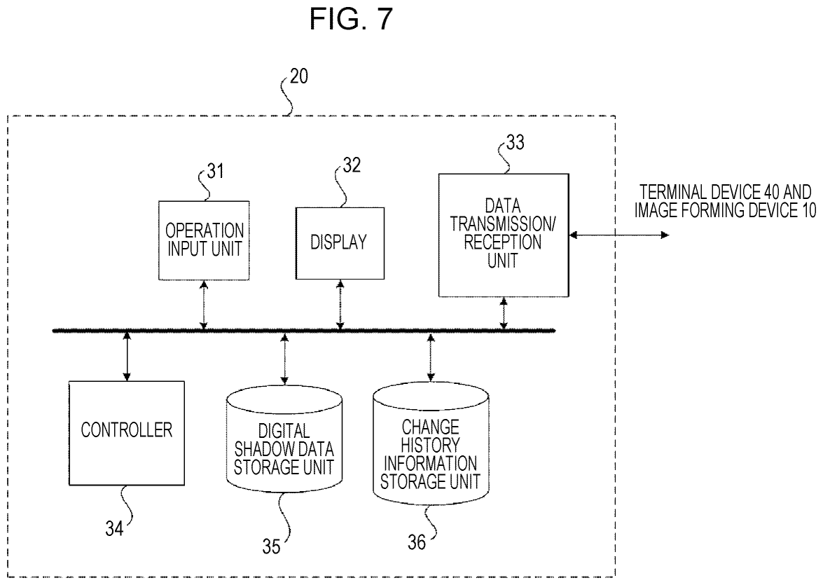

FIG. 7 is a block diagram illustrating the functional configuration of the management server 20 implemented by running the control program described above.

As illustrated in FIG. 7, the management server 20 of this exemplary embodiment includes an operation input unit 31, a display 32, a data transmission/reception unit 33, a controller 34, a digital shadow data storage unit 35, and a change history information storage unit 36.

The display 32 is controlled by the controller 34 and displays various pieces of information to the user. The operation input unit 31 is used to input the various pieces of information regarding operations performed by the user.

The data transmission/reception unit 33 exchanges data with the external devices such as the terminal device 40 and the image forming device 10.

The controller 34 receives the setting change request from the terminal device 40 via the data transmission/reception unit 33. The controller 34 transfers the setting change request received from the terminal device 40 to the image forming device 10 via the data transmission/reception unit 33. Further, the controller 34 executes the synchronization process with the image forming device 10 via the data transmission/reception unit 33 at regular intervals, acquires various pieces of information such as settings information regarding the image forming device 10 and consumables information, and stores the information in the digital shadow data storage unit 35. Regularly executing the synchronization process as described above between the image forming device 10 and the management server 20 leads to synchronization between the settings information regarding the image forming device 10 and the like and the settings information and the like in the digital shadow data storage unit 35.

As described above, the controller 34 stores the set value of the image forming device 10 serving as a management target, as a set value synchronously in the digital shadow data storage unit 35 by performing the synchronous communication with the image forming device 10.

In response to the setting change request for changing the set value of the image forming device 10 received from the terminal device 40 serving as a remote device, the controller 34 changes the set value stored in the digital shadow data storage unit 35 on the basis of the received setting change request. Further, the controller 34 transfers the received setting change request to the image forming device 10 via the data transmission/reception unit 33.

If the set values of setting items are changed in the processing steps as described above, the controller 34 stores the change histories of the setting items as the change history management table in the change history information storage unit 36.

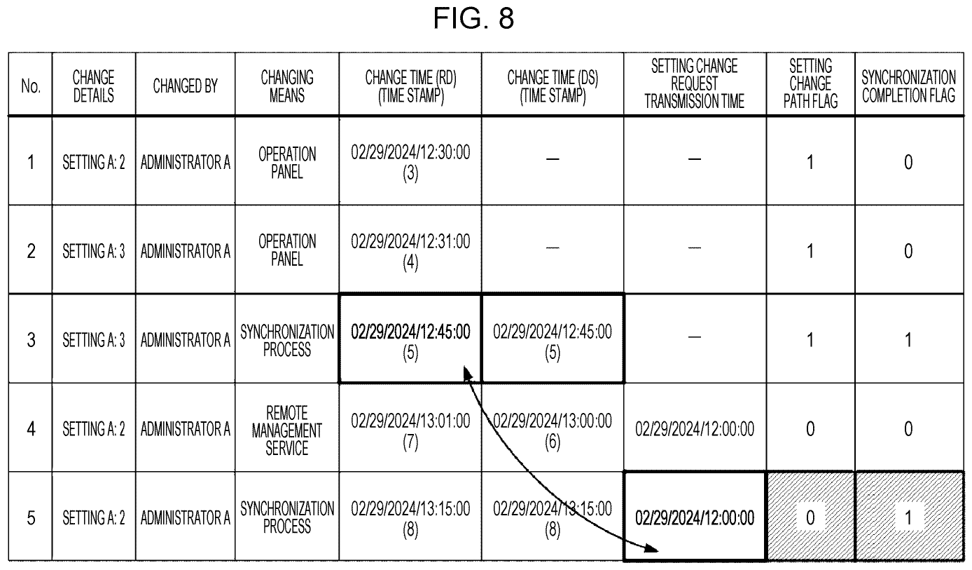

FIG. 8 illustrates an example of the change history management table stored in the change history information storage unit 36. FIG. 8 chronologically illustrates the change history of the set value changes in Setting A as the setting item that are made in a series of processing steps illustrated in FIG. 4.

The change history management table illustrated in FIG. 8 is composed of pieces of information that are Change Details of a changed set value, Changed By, Changing Means, Change Time (RD), Change Time (DS), Setting Change Request Transmission Time, Setting Change Path Flag, and Synchronization Completion Flag.

Changing Means denotes means used to change the set value. Specifically, Operation Panel denotes that the set value is changed by performing operation of the operation panel of the image forming device 10. Synchronization Process denotes that the set value is changed in a process for synchronizing the image forming device 10 and the management server 20. Further, Remote Management Service denotes that the set value is changed on the basis of a setting change request transmitted from the terminal device 40.

Change Time (RD) denotes a time stamp indicating time when the set value is changed in the image forming device 10. Likewise, Change Time (DS) denotes a time stamp indicating time when the set value is changed in the management server 20. Further, Setting Change Request Transmission Time denotes a time stamp indicating time when the setting change request is transmitted from the terminal device 40.

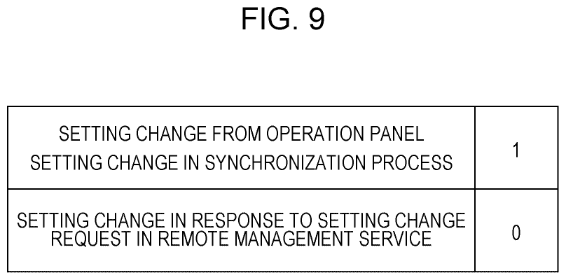

Setting Change Path Flag denotes a flag indicating a path used to change the set value. FIG. 9 illustrates conditions for the logic state of a setting change path flag. It is understood that with reference to FIG. 9, the setting change path flag is designed to be set to “1” in the case where setting change is performed by changing the set value from the operation panel or through the synchronization process. The setting change path flag is designed to “0” if setting change is performed in response to a setting change request in the remote management service. FIG. 9 illustrates logic states in a case of RD Priority as the priority setting mode.

If there is a difference between a set value of the image forming device 10 and a set value stored in the digital shadow data storage unit 35 of the management server 20 in executing the synchronization process, and if the following conditions are satisfied, the controller 34 transmits, to the administrator A serving as a report destination set in advance, a verification report suggesting that the set value be verified as an intended set value.

Specifically, the controller 34 transmits the verification report to the mail address or the like of the administrator A in the following case: RD Priority is set as the priority setting mode for deciding a priority set value; the set value is changed on the basis of the setting change request from the terminal device 40; the synchronization process is then executed; and time when the setting change request is transmitted from the terminal device 40 is earlier than time when a previous synchronization process is executed.

As described above, RD Priority denotes a setting giving priority to the set value of the image forming device 10 serving as the management target.

The controller 34 transmits the verification report suggesting that the set value be verified as the intended set value together with the change history information indicating the change history of the set values. The change history information is generated on the basis of information in the change history management table illustrated in FIG. 8 and is such information that makes knowable a history of changing the set value of Setting A. Specifically, the change history information includes information regarding transmission time that is time when the setting change request is transmitted and information regarding time when the previous synchronization process is executed.

The operations of the controller 34 performed when the verification report as described above is transmitted will be described more specifically. If RD Priority giving priority to the set value of the management target image forming device 10 is set as the priority setting mode, the controller 34 sets the setting change path flag to “0” representing an off state when the set value is changed on the basis of the setting change request from the terminal device 40. The controller 34 then sets the synchronization completion flag to “1” representing an on state when the synchronization process of the set value between the image forming device 10 and the management server 20 is executed. If the setting change path flag is “0”, and if the synchronization completion flag is “1”, the controller 34 compares the time when the setting change request is transmitted from the terminal device 40 with the time when the previous synchronization process is executed. If the time when the setting change request is transmitted from the terminal device 40 is earlier than the time when the previous synchronization process is executed, the controller 34 transmits the verification report to the mail address or the like of the administrator A.

If DS Priority giving priority to the set value of the management server 20 is set as the priority setting mode, the controller 34 sets the setting change path flag to “1” representing the on state despite the change made on the basis of the setting change request from the terminal device 40.

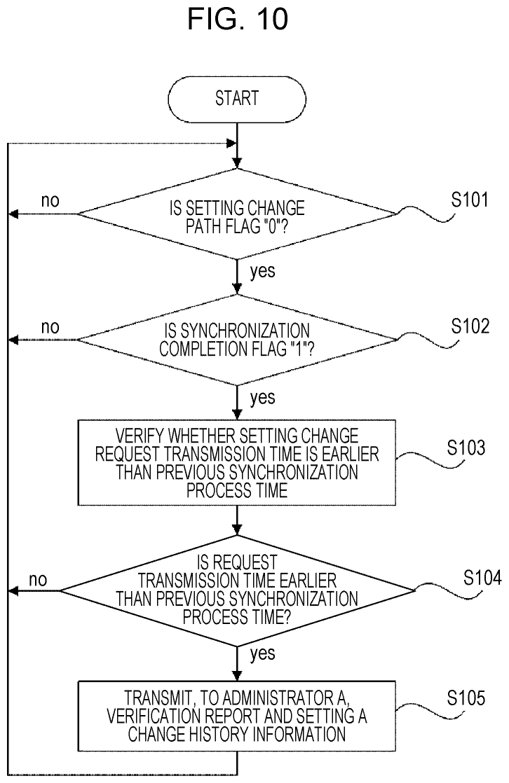

The flowchart in FIG. 10 illustrates processing performed by the controller 34 in transmitting the verification report.

First, in step S101, the controller 34 determines whether the setting change path flag in the setting change path table is “0”. If the setting change path flag is “0” in step S101, the controller 34 determines in step S102 whether the synchronization completion flag in the setting change path table is “1”. If the synchronization completion flag is “1” in step S102, the controller 34 verifies in step S103 whether transmission time of the setting change request is earlier than time of the previous synchronization process. In step S104, the controller 34 determines whether the transmission time of the setting change request is earlier than the time of the previous synchronization process. If the controller 34 determines that the transmission time of the setting change request is earlier than the time of the previous synchronization process, the controller 34 transmits, to the mail address or the like of the administrator A, the verification report together with a change history information regarding Setting A in step S105, the verification report suggesting that the set value of Setting A be verified as the intended set value.

If the setting change path flag is “1” in step S101, if the synchronization completion flag is “0” in step S102, and if the transmission time of the setting change request is not earlier than the time of the previous synchronization process in step S104, the controller 34 returns to the determination in the step S101.

A case where the determination process as described above is executed on records in the change history management table illustrated in FIG. 8 will be described. In FIG. 8, the fifth record indicates that a synchronization process after a setting change via the remote management service is executed at “02/29/2024/13:15:00”. At this time point, the setting change flag is “0”, and the synchronization completion flag is “1”. The conditions in steps S101 and S102 in the flowchart illustrated in FIG. 10 are thus satisfied. The controller 34 thus compares “02/29/2024/12:00:00” as the transmission time of the setting change request with “02/29/2024/12:45:00” as the time of the previous synchronization process. Since “02/29/2024/12:00:00” as the transmission time of the setting change request is earlier than “02/29/2024/12:45:00” as the time of the previous synchronization process, the controller 34 transmits the verification report to the administrator A together with the change history information regarding Setting A.

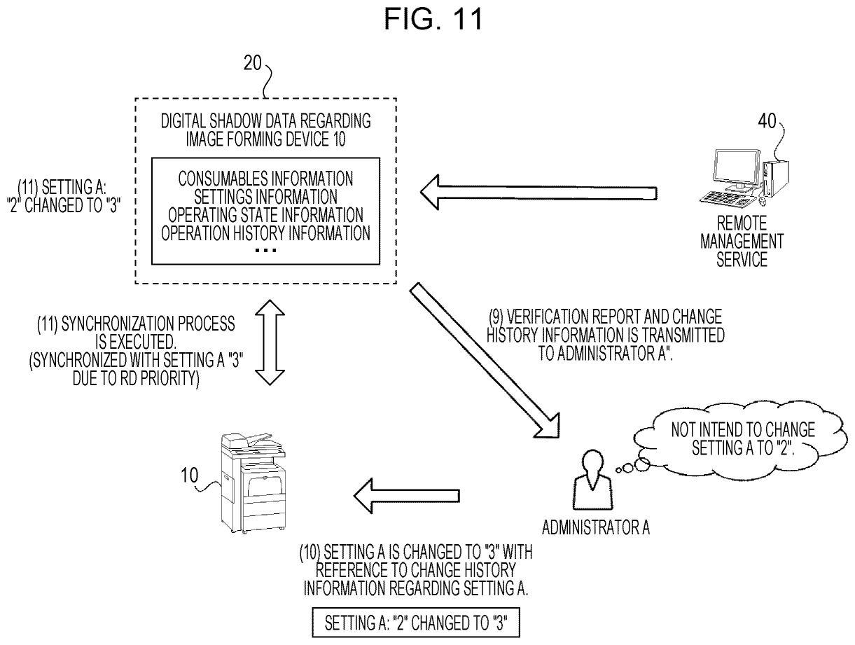

FIG. 11 illustrates processing steps in which the administrator A receives the change history information regarding Setting A and the verification report in this manner and operations after the receiving. In FIG. 11, the processing steps (9) to (11) are performed.

(9) According to the processing as described above, the controller 34 of the management server 20 transmits the verification report and the change history information regarding Setting A to the report destination of the administrator A serving as a report destination set in advance, the verification report suggesting that the set value of Setting A be verified as the intended set value.

(10) The administrator A receives the verification report, refers to the change history information transmitted together, and realizes that the set value of Setting A has been finally changed to “2”. The administrator A who realizes that the set value of Setting A has been changed to the not intended set value “2” performs operation for changing the set value of Setting A to the set value “3” from the operation panel of the image forming device 10.

(11) The process for synchronizing the management server 20 and the image forming device 10 is thereafter executed. In this case, the set value of Setting A in the digital shadow data in the management server 20 is “2”, and the set value of Setting A for the image forming device 10 is “3”. The synchronization process is thus executed to cause Setting A to have the set value “3”.

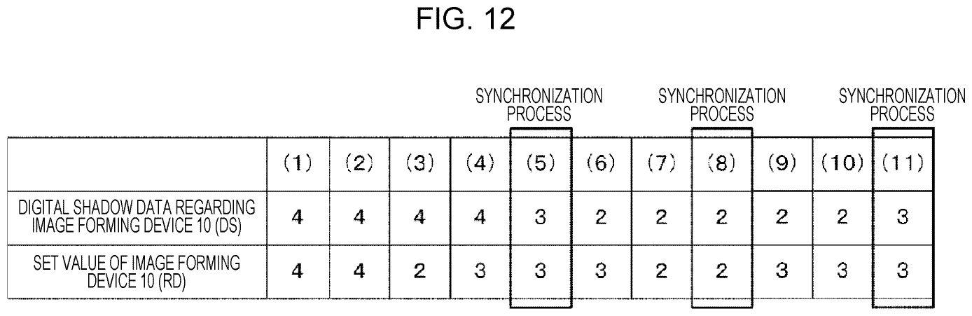

FIG. 12 illustrates the change history of the set values of Setting A according to the processing steps (9) to (11) as described above.

As understood with reference to FIG. 12, performing the processing steps (9) to (11) as described above finally leads to the set value “3” of Setting A that is intended by the administrator A in both of the image forming device 10 and the digital shadow data in the management server 20.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The term “system” in this exemplary embodiment includes both of a system including multiple devices and a system including one device.

The present disclosure is also applicable to a program and a program product.

### Modification

The exemplary embodiment above has been described by using the case where the image forming device 10 serves as the management target information processing device; however, the present disclosure is not limited to this. The present disclosure is likewise applicable to a case where a different information processing device such as a personal computer other than the image forming device 10 serves as a management target.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system includes:
a processor configured to:
   store a set value of an information processing device serving as a management target, as a set value synchronously in a management device by performing synchronous communication with the information processing device;
   in response to a setting change request for changing a set value being received from a remote device, change the stored set value on a basis of the received setting change request and transfer the received setting change request to the information processing device; and
   in response to a difference between the set value of the information processing device serving as the management target and the set value stored in the management device in executing a synchronization process, in response to priority being given, in a priority setting for deciding which one of set values is given priority, to the set value of the information processing device serving as the management target, in response to the set value being changed on the basis of the setting change request from the remote device, in response to the synchronization process being executed, and in response to time when the setting change request is transmitted from the remote device being earlier than time when a previous synchronization process is executed, transmit, to a report destination set in advance, a report for suggesting that the set value be verified as an intended set value.
      (((2)))

In the information processing system according to (((1))),
the processor is configured to: transmit the report for suggesting that the set value be verified as the intended set value together with change history information indicating a change history of the set values.
   (((3)))

In the information processing system according to (((2))),
the change history information includes information regarding the time when the setting change request is transmitted and information regarding the time when the previous synchronization process is executed.
   (((4)))

In the information processing system according to any one of (((1))) to (((3))), the processor is configured to: in response to priority being given, in the priority setting, to the set value of the information processing device serving as the management target, set a first flag to an off state when the set value is changed on the basis of the setting change request from the remote device, set a second flag to an on state when the synchronization process of the set value is executed between the information processing device and the management device, and in response to the first flag being the off state and the second flag being the on state, compare the time when the setting change request is transmitted from the remote device with the time when the previous synchronization process is executed.

(((5)))
In the information processing system according to (((4))),

the processor is configured to: in response to priority being given, in the priority setting, to the set value of the management device, set the first flag to the on state despite change of the set value made on the basis of the setting change request from the remote device.

(((6)))

A Program Causes a Computer to Execute a Process Including:
storing a set value of an information processing device serving as a management target, as a set value synchronously in a management device by performing synchronous communication with the information processing device;
in response to a setting change request for changing a set value being received from a remote device, changing the stored set value on a basis of the received setting change request and transferring the received setting change request to the information processing device; and
in response to a difference between the set value of the information processing device serving as the management target and the set value stored in the management device in executing a synchronization process, in response to priority being given, in a priority setting for deciding which one of set values is given priority, to the set value of the information processing device serving as the management target, in response to the set value being changed on the basis of the setting change request from the remote device, in response to the synchronization process being executed, and in response to time when the setting change request is transmitted from the remote device being earlier than time when a previous synchronization process is executed, transmitting, to a report destination set in advance, a report for suggesting that the set value be verified as an intended set value.

What is claimed is:

1. An information processing system comprising:
a processor configured to:
store a set value of an information processing device serving as a management target, as a set value synchronously in a management device by performing synchronous communication with the information processing device;
in response to a setting change request for changing a set value being received from a remote device, change the stored set value on a basis of the received setting change request and transfer the received setting change request to the information processing device; and
in response to a difference between the set value of the information processing device serving as the management target and the set value stored in the management device in executing a synchronization process, in response to priority being given, in a priority setting for deciding which one of set values is given priority, to the set value of the information processing device serving as the management target, in response to the set value being changed on the basis of the setting change request from the remote device, in response to the synchronization process being executed, and in response to time when the setting change request is transmitted from the remote device being earlier than time when a previous synchronization process is executed, transmit, to a report destination set in advance, a report for suggesting that the set value be verified as an intended set value.

2. The information processing system according to claim 1,
wherein the processor is configured to: transmit the report for suggesting that the set value be verified as the intended set value together with change history information indicating a change history of the set values.

3. The information processing system according to claim 2,
wherein the change history information includes information regarding the time when the setting change request is transmitted and information regarding the time when the previous synchronization process is executed.

4. The information processing system according to claim 1,
wherein the processor is configured to: in response to priority being given, in the priority setting, to the set value of the information processing device serving as the management target, set a first flag to an off state when the set value is changed on the basis of the setting change request from the remote device, set a second flag to an on state when the synchronization process of the set value is executed between the information processing device and the management device, and in response to the first flag being the off state and the second flag being the on state, compare the time when the setting change request is transmitted from the remote device with the time when the previous synchronization process is executed.

5. The information processing system according to claim 4,
wherein the processor is configured to: in response to priority being given, in the priority setting, to the set value of the management device, set the first flag to the on state despite change of the set value made on the basis of the setting change request from the remote device.

6. A non-transitory computer readable medium storing a program causing a computer to execute a process comprising:
storing a set value of an information processing device serving as a management target, as a set value synchronously in a management device by performing synchronous communication with the information processing device;
in response to a setting change request for changing a set value being received from a remote device, changing the stored set value on a basis of the received setting change request and transferring the received setting change request to the information processing device; and
in response to a difference between the set value of the information processing device serving as the management target and the set value stored in the management device in executing a synchronization process, in response to priority being given, in a priority setting for deciding which one of set values is given priority, to the set value of the information processing device serving as the management target, in response to the set value being changed on the basis of the setting change request from the remote device, in response to the synchronization process being executed, and in response to time when the setting change request is transmitted from the remote device being earlier than time when a previous synchronization process is executed, transmitting, to a report destination set in advance, a report for suggesting that the set value be verified as an intended set value.

7. An information processing method comprising:
storing a set value of an information processing device serving as a management target, as a set value synchronously in a management device by performing synchronous communication with the information processing device;
in response to a setting change request for changing a set value being received from a remote device, changing the stored set value on a basis of the received setting change request and transferring the received setting change request to the information processing device; and
in response to a difference between the set value of the information processing device serving as the management target and the set value stored in the management device in executing a synchronization process, in response to priority being given, in a priority setting for deciding which one of set values is given priority, to the set value of the information processing device serving as the management target, in response to the set value being changed on the basis of the setting change request from the remote device, in response to the synchronization process being executed, and in response to time when the setting change request is transmitted from the remote device being earlier than time when a previous synchronization process is executed, transmitting, to a report destination set in advance, a report for suggesting that the set value be verified as an intended set value.
